(19) United States
(12) Patent Application Publication
(10) Pub. No.: US 2026/0290144 A1
(43) Pub. Date: Sep. 24, 2026

(54) ALARM SYSTEM FOR DETECTING PRESSURE TANK FAILURE

(71) Applicant: Matthew Defeo, Puyallup, WA (US)

(72) Inventor: Matthew Defeo, Puyallup, WA (US)

(21) Appl. No.: 19/576,027

(22) Filed: Mar. 24, 2026

Related U.S. Application Data
(60) Provisional application No. 63/776,554, filed on Mar. 24, 2025.

(51) Int. Cl. G08B 21/18; F15B 19/00; G01M 3/32

(52) U.S. Cl. CPC G08B 21/187; F15B 19/005; G01M 3/3236; F15B 2201/505

(57) ABSTRACT

An alarm system for detecting bladder pressure tank failures is presented. The system includes a housing removably coupled to a Schrader valve of the pressure tank such that the interior of the housing is in fluid communication with the valve. In one embodiment, a continuity switch comprising electrodes is positioned within the housing to detect fluid entering from the Schrader valve, wherein contact of the fluid with the electrodes completes an electrical circuit to activate an alarm output device. In another embodiment, a pressure sensor is configured to measure pressure in the pressure tank and to trigger the alarm output device based on predefined pressure conditions. In a further embodiment, a control unit processes pressure measurements over multiple operating cycles to establish a baseline pressure-response profile and detect deviations indicative of bladder degradation.

### CROSS-REFERENCE TO RELATED APPLICATION

This application claims the benefit of U.S. Provisional Patent Application Ser. No. 63/776,554 filed on Mar. 24, 2025, which is incorporated herein by reference in its entirety.

### TECHNICAL FIELD

The present invention generally relates to water pressure regulation systems, and more specifically, to an alarm system for detecting bladder failure in expansion tanks used in plumbing system, including water heaters, boilers, and portable hot/cold heating systems.

### BACKGROUND

Pressure tanks play a critical role in plumbing and water supply systems by regulating pressure and reducing pump cycling frequency. In typical applications, when a valve is opened, a bladder pressure tank provides an immediate source of pressurized water, preventing a pump from engaging instantly. Similarly, when a valve is closed, the bladder tank absorbs excess water pumped during the delay before the pump shuts off, stabilizing system pressure and reducing wear on the pump. By maintaining a buffer of pressurized water, bladder pressure tanks enhance system efficiency, prevent rapid cycling of pumps, and extend the lifespan of system components.

Generally, a bladder pressure tank consists of a flexible, air-filled bladder enclosed within a rigid shell. This bladder serves to separate water from the pre-pressurized air chamber. As water enters the tank, the bladder compresses, maintaining a stable pressure in the system. When water is drawn from the system, the compressed air expands the bladder, supplying pressurized water without requiring the pump to activate immediately. This design ensures consistent water pressure and minimizes pump operation, contributing to overall system stability.

Over time, the bladder inside the expansion tank is subjected to repeated compression and expansion cycles, temperature fluctuations, and potential chemical interactions with water. These factors cause material degradation, resulting in micro-tears or ruptures in high-stress areas, such as folds or seams. When a rupture occurs, the pressurized air within the tank gradually dissolves into the water and escapes through normal system usage, leading to a condition known as a “waterlogged” pressure tank.

In a waterlogged state, the tank is entirely filled with water, eliminating the air cushion necessary for pressure stabilization. Since water is incompressible, even small volumetric changes within the system result in significant pressure fluctuations. When a valve is opened, the system pressure can drop rapidly from several bar to near zero, and then spike again once the pump activates. Similarly, after a valve is closed, the pump continues to run briefly, leading to further pressure spikes. These rapid and extreme variations place excessive strain on plumbing components, often leading to failures at weak points such as pipe joints, valves, and water heaters. If undetected, this failure mode can cause costly damage, leaks, and increased wear on system components.

A major drawback of existing bladder tanks is the absence of an early warning system to notify users of bladder failure. Once the bladder ruptures, water will inevitably reach the Schrader valve, which is typically used to adjust the air pressure in the tank. Existing designs fail to take advantage of this indicator, leaving system owners unaware of the failure until severe damage has already occurred. While some expansion tanks include built-in alarms, they are proprietary to specific models and do not provide a universal solution for existing installations.

There are several solutions proposed in the prior art. One of the prior art, U.S. Pat. No. 7,775,260 discloses an expansion tank integrated with an alarm system designed to detect bladder failures. The alarm system provides immediate notification of bladder rupture, enabling timely maintenance and reducing the risk of system damage caused by uncontrolled pressure changes. However, this system lacks to detect early signs of bladder degradation instead of just rupture. Further, this system is primarily for HVAC expansion tanks and may not support broader range of pressure tanks, including industrial and water supply applications.

Although various methods and systems have been developed to detect failure in the bladder pressure tank, each of these systems has its own limitations. To address these challenges, there is a need for a retrofit alarm system that can be attached to the Schrader valve of any bladder pressure tank for triggering an audible and/or visual alert, notifying the user of bladder failure before it results in significant system damage. This approach can allow a universal, non-invasive solution that can be installed on any existing bladder pressure tank.

### SUMMARY

It is an objective of the present invention to provide an alarm system designed to detect failures in bladder pressure tanks. The alarm system comprises a housing that attaches to the Schrader valve of the bladder pressure tank, an audible alarm that emits distinct sounds based on detected conditions, and a visual indicator with multi-coloured lights to signify different operational statuses. A continuity switch is configured to detect direct water ingress through the Schrader valve, and a control unit processes signals from the continuity switch to trigger the alarms upon detecting abnormal pressure conditions.

It is an objective of the present invention to provide the continuity switch consisting of two electrodes positioned inside the housing near the Schrader valve. Under normal conditions, the continuity switch remains in an open circuit state and when water ingress occurs due to bladder rupture, the circuit is completed and the alarm is triggered.

It is an objective of the present invention to provide the alarm system that may also include a snooze button that silences the alarm for up to 24 hours and automatically resets after the expiration of the snooze period. Additionally, a Wi-Fi module can be incorporated for wireless communication with an external application to enable remote monitoring and control.

In another embodiment, an alarm system for detecting failure in a bladder pressure tank, wherein the alarm system is configured to monitor pressure variations and provide audible and visual alerts upon detecting abnormal pressure conditions.

In another embodiment, an alarm system that attaches to a schrader valve of a bladder pressure tank and utilizes a pressure sensor to detect pressure changes indicative of bladder failure.

In another embodiment, an alarm system with an audible alarm emits distinct sound patterns based on different operating conditions, including multiple beeps for bladder failure warnings, a single long beep for critical failure, and short intermittent beeps at periodic intervals for low battery indication.

In another embodiment, an alarm system with a visual indicator that utilizes multiple-coloured lights to signify different operational statuses, including normal operation, bladder failure, and low battery conditions.

In another embodiment, an alarm system comprising a housing, an air fill valve, a pressure sensor, an audible alarm, a visual indicator, and a control unit. The pressure sensor is configured to detect pressure variations within a range of 0-120 PSI and transmit real-time data to the control unit. The control unit is further configured to process the pressure readings and, upon detecting pressure conditions that exceed a factory-set minimum or maximum threshold, triggers the alarm by activating the audible alarm and visual indicator.

In another embodiment, the pressure sensor functions as an active pressure gauge, ensuring that if water does not reach the sensor, the system detects the drop in pressure and triggers the alarm.

In another embodiment, the alarm system is powered by either a battery or a plug-in adapter, allowing for flexible power supply options.

In another embodiment, the alarm system includes a Wi-Fi module to enable wireless communication with an external application, allowing for remote monitoring, real-time alerts, firmware updates, and predictive maintenance.

In another embodiment, the external application is integrated with one or more smart home platforms to enable remote diagnostics, system updates, and enhanced monitoring capabilities.

In another embodiment, the external application provides historical data analysis and subscription-based monitoring services, enabling predictive maintenance and advanced failure detection.

In another embodiment, the control unit is configured to analyse pressure readings and differentiate between normal fluctuations and potential bladder failures, ensuring that false alarms are minimized while maintaining accurate fault detection.

Further, the present invention relates to an alarm system for detecting failure and abnormal operation of a bladder pressure tank. The system includes a housing configured to be removably coupled to a Schrader valve of the bladder pressure tank such that an interior of the housing is in fluid communication with the Schrader valve.

In one embodiment, the alarm system includes a continuity switch having a plurality of electrodes positioned within the housing to be exposed to fluid entering from the Schrader valve. Upon bladder failure, fluid exiting the Schrader valve contacts the electrodes to complete an electrical circuit, thereby triggering an alarm output device. The electrodes may be positioned adjacent to the Schrader valve interface or within or near an adapter disposed on the housing. The alarm output device may include an audible alarm and/or a visual indicator configured to provide different signals corresponding to different operating conditions. The system may further include user controls, such as a snooze function, and communication capabilities for transmitting alerts to external devices.

In another embodiment, the alarm system includes a pressure sensor configured to measure pressure associated with the bladder pressure tank via the Schrader valve, and a control unit configured to activate an alarm output device when the measured pressure satisfies predefined conditions indicative of abnormal operation, including pressure drops associated with bladder degradation.

In a further embodiment, the system provides adaptive monitoring of the bladder pressure tank by collecting pressure measurements over multiple operating cycles, determining pressure-response characteristics, and establishing a baseline pressure-response profile representative of normal operation. The control unit compares subsequently obtained pressure measurements with the baseline profile to identify deviations indicative of degradation of the bladder. The system may further update the baseline profile over time and determine a degradation state of the bladder, enabling early detection of failure conditions prior to rupture.

The present invention provides an alarm system for monitoring bladder pressure tanks by incorporating a continuity switch to detect direct water ingress through the Schrader valve, thereby enhancing failure detection capabilities. These and other features and advantages of the present invention will become apparent from the detailed description below, in light of the accompanying drawings.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the figures, and

FIG. 1 illustrates an alarm system for detecting pressure tank failure, according to an embodiment of the present invention;

FIG. 2 illustrates an exemplary exploded view of the alarm system for detecting pressure tank failure, according to an embodiment of the invention;

FIG. 3 illustrates a top view of the alarm system for detecting pressure tank failure, according to an embodiment of the invention;

FIG. 4 illustrates a side perspective view of the alarm system with a battery door open, according to an embodiment of the invention;

FIG. 5 illustrates an alarm system for detecting pressure tank failure, according to another embodiment of the present invention;

FIG. 6A-6E illustrates different types of alarm systems for detecting pressure tank failure, according to another embodiment of the present invention;

FIG. 7A illustrates a front view of the alarm system showing a user interface according to an embodiment of the present invention;

FIG. 7B illustrates a rear view of the alarm system according to an embodiment of the present invention;

FIGS. 8A and 8B illustrate an installation sequence of the alarm system onto a Schrader valve of a bladder pressure tank, according to an embodiment of the present invention;

FIG. 8C illustrates a programming sequence of the alarm system for configuring operational parameters according to an embodiment of the present invention; and

FIG. 8D illustrates an adjustment sequence for setting pressure limits of the alarm system according to an embodiment of the present invention.

### DETAILED DESCRIPTION

Before describing the present invention in detail, it should be observed that the present invention utilizes a combination of components or processes, which constitutes an alarm system for detecting bladder failure in expansion tanks. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

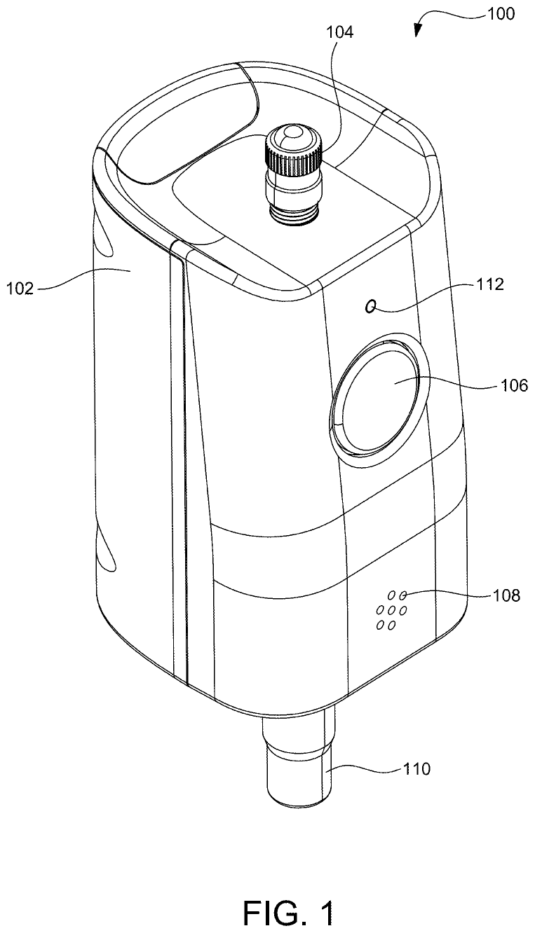

The alarm system for detecting pressure tank failure, according to various embodiments of the present invention, will now be described with reference to the accompanying drawings, particularly FIGS. 1-6 (6A-6E).

FIG. 1 illustrates a front perspective view of an alarm system 100, according to an embodiment of the invention. The alarm system 100 provides early detection of failure of bladder in a pressure tank (not seen). The alarm system 100 comprises a housing 102, an air fill valve 104, a snooze button 106, a buzzer 108, a National Pipe Thread (NPT) adapter 110, a visual indicator 112, and a continuity switch with two electrodes (not seen). The NPT adapter 110 serves as the connection point for the alarm system 100 allowing to monitor the pressure within the pressure tank effectively. The NPT adapter 110 ensures a secure connection and compatibility of the alarm system 100 with various pressure tank designs. The continuity switch detects direct water ingress through the Schrader valve of the pressure tank.

In an embodiment, as seen in FIG. 1, the air fill valve 104 of the alarm system 100 is a schrader valve 104 configured to facilitate the introduction and maintenance of air pressure within the bladder of the pressure tank. The schrader valve 104 serves as a primary access point for inflating the bladder to the required pressure levels, ensuring proper operation of the tank by allowing controlled compression and expansion of the bladder as water enters and exits. The valve 104 is designed with a spring-loaded core that automatically seals when air is not being added, preventing leakage and ensuring long-term pressure retention.

In an embodiment, as seen in FIG. 1, the snooze button 106 of the alarm system 100 is configured to temporarily silence the audible alarm 108 in response to a user input, allowing for a controlled delay in audio alarm notifications while maintaining continuous system monitoring. Upon activation, the snooze button 106 deactivates the audible alarm for a predetermined period, such as up to 24 hours, after which the alarm automatically resets to ensure uninterrupted detection of pressure anomalies. This feature provides users with flexibility in managing alarm notifications while preventing prolonged suppression of critical alerts. The snooze function does not interfere with the operation of the visual indicator 112, ensuring that a visual status of the system 100 remains available even when the audible alarm is silenced. The snooze button 106 is designed for ease of access and operation, allowing users to respond to alerts efficiently while maintaining the integrity of the alarm system's monitoring functions.

In an embodiment, as seen in FIG. 1, the audible alarm 108 is implemented as a speaker configured to emit distinct sound patterns corresponding to various operational conditions of the bladder pressure tank. The speaker may be of various types, including but not limited to piezoelectric buzzers, electromagnetic buzzers, or dynamic speakers, each selected based on power consumption, sound output, and durability requirements. A piezoelectric buzzer may be used for low-power applications, providing a high-pitched tone with minimal energy consumption. An electromagnetic buzzer offers a compact design with reliable sound output that is suitable for environments requiring moderate volume levels. Alternatively, a dynamic speaker may be employed for enhanced sound clarity and volume, ensuring audibility in high-noise environments. The audible alarm 108 is configured to generate distinct sound patterns based on different operating conditions, including multiple beeps for bladder failure warnings, a single long beep for critical failure, and short intermittent beeps at periodic intervals for low battery indication. For example, the audible alarm 108 is configured to generate multiple beeps to indicate a warning related to bladder failure, a single long beep for critical failure, and short intermittent beeps every 5 to 10 minutes for a low battery condition. The alarm is activated in response to water flow from the Schrader valve of the pressure tank in the housing 102 and makes direct contact with both electrodes or signals from a control unit on a printed circuit board (PCB) 206 which processes pressure data from the MEMS pressure sensor. The inclusion of various speaker types ensures adaptability for different use cases, optimizing performance based on power supply options such as a 9V battery or a plug-in adapter 502.

In an embodiment, as seen in FIG. 1, the NPT adapter 110 is a threaded fitting designed to facilitate the secure attachment of the alarm system 100 to the bladder pressure tank, enabling accurate pressure monitoring and failure detection. The adapter is configured with National Pipe Thread (NPT) standards, ensuring compatibility with commonly used air fill valve fittings on bladder pressure tanks. The NPT adapter 110 provides a leak-proof connection between the enclosure 102 of the alarm system 100, allowing the integrated pressure sensor on the PCB 206 to accurately measure air pressure within the tank. The electrodes of the continuity switch are fixed within the NPT adapter 110 ensuring direct exposure to any water ingress from the Schrader valve of the expansion tank. The strategic placement of electrodes enhances the reliability of failure detection as the electrodes are positioned at a critical junction where water first escapes due to bladder rupture. The NPT adapter 110 may be constructed from corrosion-resistant materials, such as brass, stainless steel, or high-strength polymer, to ensure durability in varying environmental conditions. The design of the NPT adapter 110 prevents air leakage, maintains consistent pressure readings, and ensures long-term operational reliability. Proper threading and sealing mechanisms, such as Teflon tape or O-rings, may be incorporated to enhance the airtight connection. By securely coupling the alarm system 100 to the bladder pressure tank, the NPT adapter 110 ensures precise pressure detection, enabling timely alerts for bladder failure, low pressure, or over-pressurization. The NPT adapter's standardized threading allows easy installation and removal, facilitating maintenance and compatibility with a wide range of pressure tank models.

In an embodiment, the electrodes of the continuity switch are positioned within the housing 102 in proximity to the Schrader valve interface, including within or adjacent to the NPT adapter 110, such that fluid exiting the Schrader valve 104 upon bladder failure directly contacts the electrodes. The electrodes may be arranged at any location along the fluid path extending from the Schrader valve 104 into the housing 102, provided that the electrodes are exposed to fluid emerging from the Schrader valve 104. This configuration enables early detection of bladder rupture at the point of fluid egress.

In an embodiment, as seen in FIG. 1, the visual indicator 112 is a signaling component configured to provide a visual representation of the operational status of the alarm system 100 based on detected pressure conditions within the bladder pressure tank. The visual indicator 112 is in electrical communication with the control unit on the PCB 206 and is activated in response to pressure readings received from the MEMS pressure sensor. The visual indicator 112 is configured to operate in conjunction with the audible alarm 108 to enhance user awareness through both visual and auditory alerts. The visual indicator 112 comprises one or more light-emitting diodes (LEDs) or other low-power illumination components, such as an organic light-emitting diode (OLED) display. The visual indicator 112 is configured to emit different colors and blinking patterns, each corresponding to a specific condition of the bladder pressure tank.

In an embodiment, as seen in FIG. 1, when the bladder of the pressure tank is intact, the air chamber within the pressure tank remains pressurized and the Schrader valve does not release any water. However, in the event of a bladder ruptures, the water escapes into the air chamber and eventually flows out of the Schrader valve of the pressure tank. The alarm system 100 incorporates a continuity switch with two electrodes positioned inside the alarm housing 102 near the Schrader valve. Under normal conditions, the circuit remains open due to the absence of water. When water exits the Schrader valve of the pressure tank due to bladder rupture and flows into the housing 102 and makes direct contact with the both electrodes. The presence of water completes the electrical circuit which immediately triggers the alarm of the alarm system 100.

In an embodiment, as seen in FIG. 1, upon activation of the continuity switch, the control unit processes the signal from the continuity switch and initiates a sequence of warning responses. The audible alarm emits a distinct beeping pattern and alerts users to the bladder failure. Simultaneously, the visual indicator changes to a warning state, ensuring that the failure is noticeable even in noisy environments. The control unit continuously monitors the status of the continuity switch and ensures that the alarm remains active as long as water is present within the alarm housing.

In an embodiment, as seen in FIG. 1, the alarm system 100 is designed to be resistant to false alarms caused by condensation or minor leaks. The positioning of the electrodes ensures that only a significant amount of water from the bladder rupture will trigger the alarm. The enclosure of the alarm system 100 is sealed to protect internal electronics while allowing efficient water ingress detection. The alarm system 100 is powered by either a battery or an external power source to ensure continuous operation even in the event of a power failure.

In an embodiment, as seen in FIG. 1, in particularly early detection mechanism allows users to take corrective action before severe plumbing damage occurs. The alarm system 100 provides a straightforward yet highly effective solution to detecting bladder ruptures and prevents costly repairs while maintaining system integrity. The incorporation of the continuity switch ensures a reliable method for detecting bladder rupture of the expansion tanks.

Additionally, the system 100 includes a transmitter (not shown) that enables remote monitoring, allowing users to receive alerts via Wi-Fi connectivity or similar smart home monitoring technologies. This connectivity enables real-time notifications to be sent to a smartphone, computer, or other networked device, ensuring prompt awareness of bladder tank failures or maintenance needs, even when users are offsite.

In an embodiment, the alarm system 100 can be implemented as a simple open circuit incorporating a voltage source and a piezoelectric alarm, such as a buzzer or speaker. In this configuration, water entering through a Schrader valve completes the circuit, triggering a continuous audible tone to alert users of a bladder failure. This low-tech approach provides a cost-effective and reliable failure detection method without requiring complex electronics. In another embodiment, the alarm system 100 may include a capacitor and an inductor within the circuit to regulate the alarm's activation, enabling intermittent chirping instead of a continuous tone. This design enhances user awareness while conserving power and reducing alarm fatigue. In yet another embodiment, the alarm system 100 can integrate processors and firmware to enable more sophisticated monitoring and alerting capabilities. These embodiments may feature programmable alarm patterns, self-diagnostics, and connectivity options such as Wi-Fi or Bluetooth for remote notifications through smart home monitoring systems. These advanced designs ensure greater adaptability and user convenience, making the system suitable for a wider range of applications.

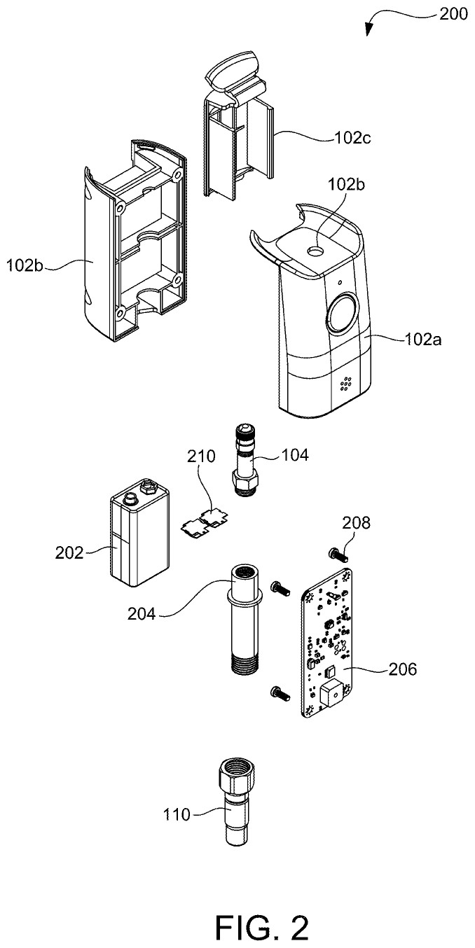

Referring to FIG. 2 an exploded view of the alarm system 100, depicting its various components and their assembly is shown. The enclosure 102 is composed of a front enclosure 102a and a rear enclosure 102b, which together form a protective housing for the internal electronic components. A battery door 102c is integrated into the enclosure 102 to provide access to the power supply compartment, facilitating battery replacement and maintenance. The alarm system 100 is powered by a battery 202, which serves as the primary energy source for the control unit and other electronic components. In certain embodiments, the system 100 may also support an external power source, such as a plug-in adapter 502. The PCB 206 is positioned within the enclosure 102 and contains the continuity switch, the pressure sensor and the control unit. The pressure sensor, likely a MEMS pressure chip, is configured to monitor pressure levels within the bladder pressure tank, detecting anomalies indicative of bladder failure. The control unit is configured to process real-time sensor data and activates the alarm system 100 upon detecting pressure deviations beyond predefined thresholds. A pipe 204 is included in the assembly to facilitate the transmission of air pressure from the bladder pressure tank to the pressure sensor. The pipe 204 ensures accurate pressure readings by maintaining a direct and unobstructed path for air pressure to reach the pressure sensor on PCB 206. The assembly is secured using screws 208, which fasten the front enclosure 102a and rear enclosure 102b together, ensuring a durable and sealed housing for the internal components. Additionally, a keystone 210 is incorporated into the design to provide structural support and alignment for the internal components, maintaining proper positioning and stability during operation. The exploded view in FIG. 2 provides a comprehensive representation of the structural and functional integration of the components within the alarm system 100, demonstrating how the system 100 is assembled to ensure reliable performance in detecting failures in bladder pressure tanks.

In another embodiment, the alarm system 100 for detecting failure in the bladder pressure tank is configured to monitor pressure changes indicative of bladder deterioration or malfunction. The alarm system 100 is designed to attach to the bladder pressure tank (via the NPT adapter 110) and detect pressure fluctuations that may signify bladder failure. The alarm system 100 is configured in the form of the enclosure 102, the enclosure 102 is configured to protect the internal electronic components and facilitates secure attachment to the bladder pressure tank. The alarm system 100 incorporates a pressure sensor on the PCB 206 to measure air pressure within the bladder tank. In one embodiment, the pressure sensor is a MEMS pressure chip capable of detecting pressure variations within a range of 0-120 PSI. The sensor continuously monitors air pressure and transmits data to a control unit, also located on PCB 206, which processes the readings to determine whether the pressure is within acceptable thresholds. The control unit is configured to recognize abnormal pressure conditions, such as excessive pressure loss, bladder rupture, or over-pressurization, and activate the alarm system 100 accordingly. The alarm system 100 further includes a pressure gauge, ensuring that in the event water does not reach the sensor, the system 100 continues to detect the drop in pressure, triggering the alarm. The control unit may be factory-calibrated with preset minimum and maximum pressure thresholds of the bladder pressure tanks. If the pressure inside the bladder tank falls below the factory-set minimum pressure or exceeds the maximum threshold, the control unit is enabled to send a warning signal to the audible alarm 108, triggering multiple beeps to alert the user. These predefined pressure settings ensure early detection of potential bladder failure.

In another embodiment, upon detecting an abnormal pressure condition, the control unit is configured to trigger the audible alarm 108, which emits distinct sound patterns based on the detected issue. The audible alarm 108 configured to emit distinct sound patterns based on different operating conditions, including the multiple beeps for bladder failure warnings, the single long beep for critical failure, and the short intermittent beeps at periodic intervals for low battery indication. For example, the audible alarm 108 is configured to emit multiple beeps to indicate a warning related to potential bladder failure, a single long beep to signify a critical failure in the bladder tank, and short intermittent beeps every 5 to 10 minutes to notify users of a low battery condition. In addition to the audible alarm, the alarm system 100 may feature a visual indicator 112 configured to emit a steady green light to indicate normal operation, a flashing yellow light to warn of potential bladder degradation, a flashing or steady red light to indicate critical failure, and a blinking low-power light (red or orange) to signify a low battery condition. To provide user control over the audible alarm 108, the alarm system 100 includes the snooze button 106, which may allow users to temporarily silence the alarm for a predefined period of up to 24 hours. After the expiration of the snooze period, the alarm automatically resets, ensuring continued monitoring of pressure conditions. The alarm system 100 is powered by the battery 202, which may be a 9V battery or an external plug-in adapter 502. The battery compartment is accessible via a battery door 102c, allowing for easy replacement and maintenance.

In another embodiment, the alarm system 100 may include a Wi-Fi module to enable wireless communication with an external application. This feature allows for remote monitoring, real-time alerts, historical data analysis, and predictive maintenance through an integrated smart home platform. The external application may further support firmware updates, subscription-based monitoring services, and remote diagnostics to enhance system performance and reliability. By integrating real-time pressure monitoring, audible and visual alerts, a snooze function, a pressure gauge, and optional Wi-Fi connectivity, the alarm system 100 may offer a comprehensive solution for detecting and notifying users of bladder failure in pressure tanks. The design ensures easy installation, reliable operation, and compatibility with a wide range of pressure tank systems.

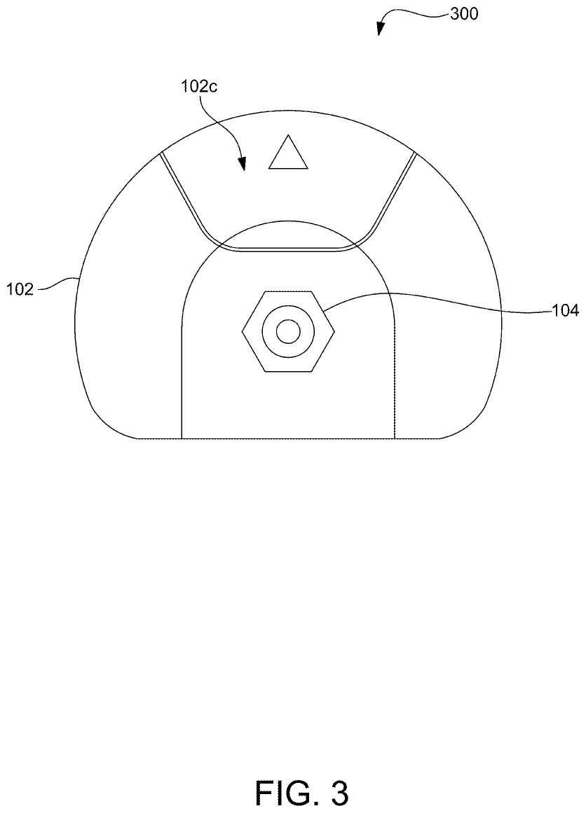

Referring to FIG. 3 that illustrate a top view of the alarm system 100, showing the enclosure 102, the air fill valve 104, and the battery door 102c. The enclosure 102 serves as a protective housing for internal components, including the PCB 206 with the pressure sensor and control unit, the battery 202, and alarm mechanisms.

Referring to FIG. 4 that illustrate the opening of the battery compartment in the alarm system 100, showing the battery door 102c and the battery 202. The battery door 102c is designed to provide access to the battery 202, allowing for easy replacement and maintenance. The battery 202 serves as the primary power source for the alarm system 100, supplying energy to the PCB 206, pressure sensor, control unit, audible alarm 108, and visual indicator 112. The design of the battery compartment ensures secure closure to prevent accidental dislodging while allowing quick and convenient battery replacement.

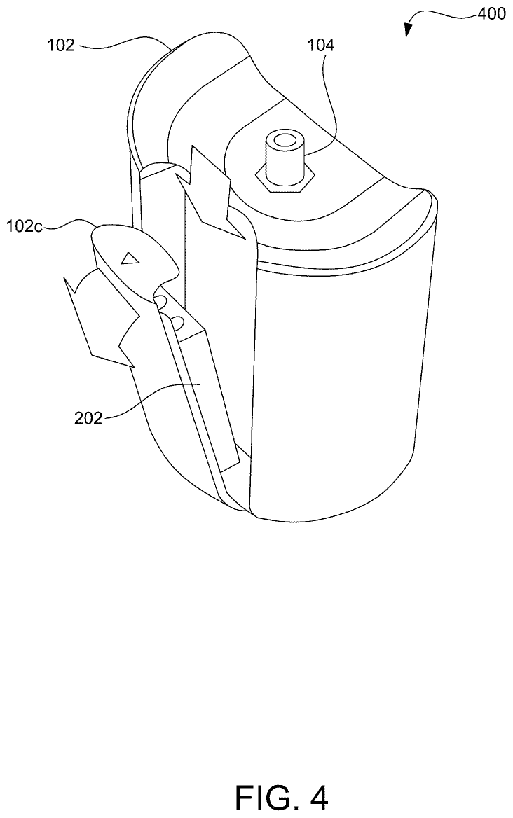

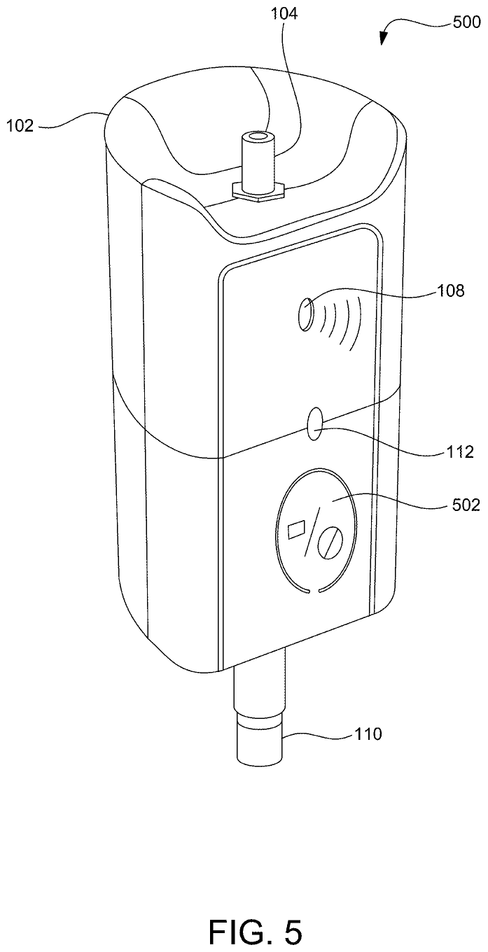

Referring to FIG. 5 that illustrate another embodiment of the alarm system 100, incorporating a plug-in adapter 502 as an alternative power supply option. In this embodiment, the system 100 can be powered by an external AC power source instead of or in addition to the battery 202, ensuring continuous operation without dependency on battery life. The plug-in adapter 502 connects to the enclosure 102 and supplies power to the PCB 206, pressure sensor, control unit, audible alarm 108, and visual indicator 112. The NPT adapter 110, the air fill valve 104, the visual indicator 112, and the audible alarm 108 function similar to the battery-powered embodiment described above, providing alerts in response to pressure anomalies detected by the MEMS pressure sensor. By integrating the plug-in adapter 502, this embodiment offers a continuous power source for extended monitoring, making it particularly beneficial for long-term installations where minimizing battery maintenance is a priority. The design maintains all core functionalities of the alarm system 100 while enhancing reliability by providing dual power options for flexible operation.

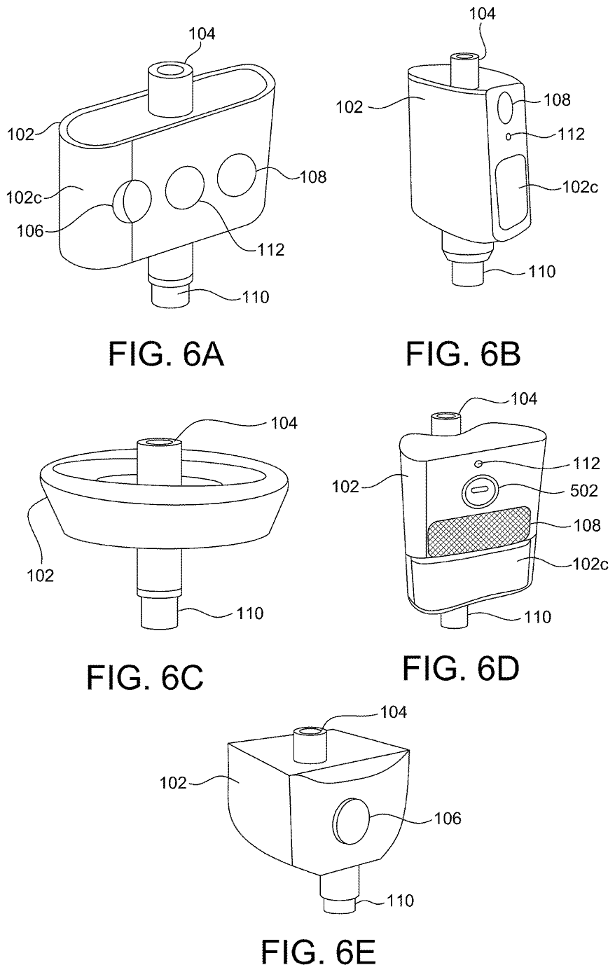

Referring to FIG. 6, specifically to FIG. 6A through FIG. 6E that illustrate various embodiments of the alarm system 100, specifically differing in the placement of the visual indicator 112, buzzer 108, and snooze button 106. These configurations provide flexibility in design to accommodate different user preferences, installation constraints, and visibility requirements. In another embodiment, in FIG. 6A, the visual indicator 112, the buzzer 108, and the snooze button 106 are aligned in a horizontal position on the front surface of the enclosure 102, ensuring high visibility and accessibility. The FIG. 6A configuration allows users to easily interact with the system 100 while ensuring that visual and audible alerts are clearly perceptible. In another embodiment, in FIG. 6B, the buzzer 108, the visual indicator 112 and the battery door 102c are aligned in a vertical position on the front surface of the enclosure 102, while the buzzer 108 and button 106 may remain on the top surface (not seen). The FIG. 6B configuration provides compact arrangement, making it effective for narrow installations where a stacked configuration ensures optimized space utilization while maintaining visibility and accessibility. In another embodiment, in FIG. 6C, where only the enclosure 102, air fill valve 104, and NPT adapter 110 are shown. The visual indicator 112, buzzer 108, and snooze button 106 are not shown in FIG. 6C. The FIG. 6C configuration highlights the attachment mechanism of the alarm system 100 to the bladder pressure tank through the Schrader valve 104 and NPT adapter 110. In another embodiment, in FIG. 6D, where the visual indicator 112, the plug-in adapter 502, the buzzer 108, and the battery door 102c are arranged vertically on the front surface of the enclosure 102. The FIG. 6D configuration provides a clear and organized layout, ensuring easy identification of alerts while offering dual power options. The plug-in adapter 502 allows for continuous external power supply, while the battery compartment, accessible via the battery door 102c, ensures backup power when needed. This arrangement optimizes visibility and accessibility, making it suitable for installations requiring both power flexibility and efficient alert notification. In another embodiment, in FIG. 6E, where only the snooze button 106 is shown on the front surface of the enclosure 102, while the other components for example the visual indicator 112 and the buzzer 108 etc are not shown in the FIG. 6E. The FIG. 6E is an alternative placement where the alarm indicators may be positioned elsewhere on the enclosure or integrated differently based on the installation requirements.

The placement of the visual indicator 112, the buzzer 108, the snooze button 106, the battery door 102c in the enclosure 102 of the alarm system 100 may differ based on functional requirements, user preferences, and installation constraints. The components may be arranged in horizontal, vertical, diagonal, or angled orientations to optimize visibility, accessibility, and sound propagation. The enclosure 102 may be formed as a unitary structure or as a multi-piece assembly, allowing for variations in size, shape, and design to accommodate different aesthetic and functional considerations. The enclosure 102 may be constructed from various materials and incorporate different surface finishes, contours, or structural reinforcements to enhance durability and usability. The variations in component placement and enclosure 102 design do not limit the scope of the invention but rather allow for adaptability in different operational environments while maintaining the intended functionality of the alarm system 100. Also, although the implementation of the alarm system 100 of the present invention is shown in pressure tanks, it should be understood that the alarm system may be used with diaphragm pressure tanks or other similar tanks.

In another embodiment, the alarm system 100 is configured to perform adaptive predictive monitoring of a bladder pressure tank by analyzing pressure-response behavior obtained via a pressure sensor coupled to the Schrader valve interface. The system is configured to detect progressive degradation of the bladder prior to rupture by evaluating changes in pressure characteristics during operation of the pressure tank.

The pressure sensor disposed on the printed circuit board (PCB) 206 is configured to obtain pressure measurements from the air chamber of the bladder pressure tank during a plurality of operating conditions, including water draw events, pump activation cycles, idle conditions, and pressure recovery phases. The measured pressure data is communicated to a control unit comprising a processor and memory.

The control unit is configured to perform an initial training phase, during which pressure measurements are collected over a plurality of operating cycles to establish a baseline pressure-response profile representative of normal operation of the pressure tank. During the training phase, the control unit extracts one or more pressure-response parameters, including pressure decay rate, pressure recovery slope, peak pressure values, pressure retention characteristics, and oscillation behavior, each corresponding to physical characteristics of the bladder and air chamber.

The baseline pressure-response profile is generated based on the extracted parameters and is specific to the installed pressure tank, thereby accounting for variations in tank structure, installation conditions, and usage patterns. The training phase may be conducted over a predetermined time duration or number of operating cycles sufficient to characterize stable system behaviour.

Following establishment of the baseline pressure-response profile, the control unit is configured to perform real-time monitoring by continuously acquiring pressure measurements and deriving corresponding pressure-response parameters. The control unit compares the real-time parameters with the baseline pressure-response profile to identify deviations indicative of bladder degradation.

Such deviations include, but are not limited to, an increase in pressure decay rate, reduction in pressure retention, abnormal pressure oscillations, or changes in pressure recovery characteristics following pump activation. These deviations correspond to physical changes in the bladder pressure tank, including gradual loss of air charge, material fatigue, or formation of micro-leaks within the bladder.

In an embodiment, the control unit is configured to implement adaptive updating of the baseline pressure-response profile based on newly acquired pressure data associated with stable operating conditions, thereby enabling the system to maintain an accurate representation of normal tank behaviour over time while excluding transient anomalies.

The control unit is further configured to determine a degradation state of the bladder based on the magnitude and persistence of the detected deviations. The degradation state may include multiple levels, such as normal operation, early-stage degradation, advanced degradation, and imminent failure, enabling the system 100 to provide predictive alerts prior to rupture of the bladder.

In an embodiment, the control unit derives dynamic detection thresholds from the baseline pressure-response profile, such that threshold values are automatically adjusted based on learned pressure behaviour of the specific pressure tank. This adaptive thresholding reduces false alarms associated with normal pressure fluctuations while improving sensitivity to abnormal conditions. Upon detection of a degradation state exceeding a predetermined level, the control unit activates the audible alarm 108 and visual indicator 112 with distinct patterns corresponding to the severity of the detected condition. The system may further transmit notifications to external devices via a communication module to enable remote monitoring and maintenance planning.

In another embodiment, the control unit may estimate a remaining operational condition of the bladder based on observed trends in pressure-response parameters and generate maintenance recommendations, including inspection, air recharge, or replacement of the pressure tank.

In certain embodiments, the processing of pressure-response parameters may be implemented using computational models configured to identify patterns in the pressure data, wherein such models operate on sensor-derived physical measurements to improve detection accuracy of bladder degradation. By utilizing adaptive training, real-time pressure-response evaluation, and dynamic thresholding, the system 100 provides a technical improvement in pressure tank monitoring, enabling early detection of bladder degradation conditions that are not detectable using static threshold-based systems or post-failure indicators.

In an embodiment, the control unit of the alarm system 100 is configured to implement a time-series processing algorithm for analyzing pressure measurements obtained from the pressure sensor coupled to the Schrader valve interface, wherein the control unit receives sequential pressure data at predefined sampling intervals and processes the data to derive pressure-response parameters corresponding to physical operation of the bladder pressure tank, including a rate of pressure change, pressure decay during water draw events, pressure recovery following pump activation, peak and minimum pressure values, and oscillatory pressure characteristics, and wherein such parameters are computed over one or more operating cycles using sliding time windows; during a training phase, the control unit is configured to construct a baseline model of normal tank behavior by determining statistical characteristics of the pressure-response parameters, including mean values, variances, and covariance relationships, thereby establishing a reference profile representative of normal physical operation of the bladder and air chamber, and wherein the baseline model is stored in memory and updated over time based on additional pressure measurements associated with stable operating conditions; in operation, the control unit is further configured to compute, for each newly acquired set of pressure-response parameters, a deviation value relative to the baseline model using a multivariate distance metric, including a Mahalanobis distance computed based on the difference between a current parameter vector and the baseline mean vector and scaled by a covariance matrix of the baseline model, such that the deviation value quantifies the extent to which current pressure behaviour differs from normal operation, and wherein the control unit further evaluates temporal sequences of the pressure-response parameters across multiple operating cycles to identify progressive trends including increasing pressure decay rate, reduced pressure retention, or increasing oscillatory instability, each indicative of physical degradation of the bladder; the control unit is additionally configured to update the baseline model using incremental learning based on a weighted averaging process or exponential moving average applied to newly acquired pressure-response parameters, thereby adapting the model to long-term stable changes while maintaining sensitivity to abnormal deviations; based on the computed deviation values and identified temporal trends, the control unit classifies an operational state of the bladder pressure tank into one or more degradation states including normal operation, early degradation, advanced degradation, and imminent failure, and generates corresponding control outputs including activation of an audible alarm 108, activation of a visual indicator 112, and transmission of alerts to external systems, and wherein the processing of pressure-response parameters may further be implemented using a trained computational sequence model configured to receive sequences of pressure-response parameters and predict future pressure behaviour for comparison with the baseline model, thereby enabling detection of degradation conditions prior to rupture, wherein all such processing is performed on sensor-derived physical measurements to improve detection accuracy and reliability of the pressure tank monitoring system.

In an embodiment, the control unit is configured to implement a multi-stage processing architecture comprising a first-level processing module and a second-level processing module, wherein the first-level processing module is configured to receive time-series pressure measurements from the pressure sensor and generate derived pressure-response parameters corresponding to physical behavior of the bladder pressure tank, including pressure decay rate, pressure recovery characteristics, and oscillatory pressure components, and further compute a deviation value relative to a baseline pressure-response profile, wherein the deviation value quantifies a degree of abnormality in the measured pressure behavior; the output of the first-level processing module, comprising the derived pressure-response parameters and the deviation value, is provided as input to the second-level processing module, which is configured to evaluate temporal sequences of the derived parameters across multiple operating cycles to identify progressive trends indicative of bladder degradation, including increasing deviation values, reduction in pressure retention, and increasing instability in pressure response; the second-level processing module is further configured to classify an operational state of the bladder pressure tank into one or more degradation states based on the evaluated trends and to generate predictive outputs indicative of a likelihood of future failure; in an embodiment, the first-level processing module operates as a feature extraction and anomaly detection stage, while the second-level processing module operates as a state interpretation and prediction stage, thereby enabling improved detection of gradual degradation conditions while reducing sensitivity to transient noise or short-term fluctuations in pressure measurements.

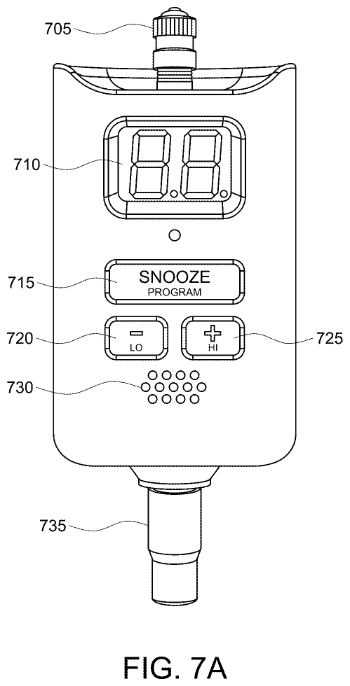

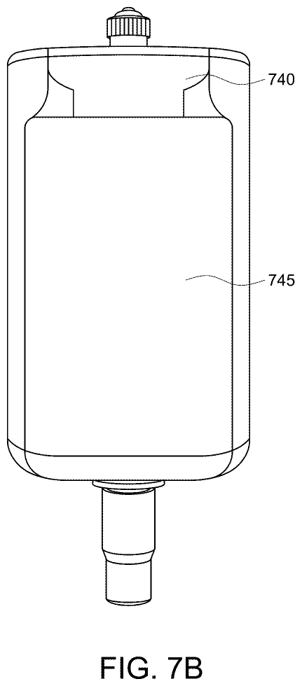

Referring to FIG. 7A, a front view of an alarm system is illustrated, depicting an external interface configuration of the alarm system, according to an embodiment of the present invention. The alarm system includes a housing configured to be removably coupled to a Schrader valve of a bladder pressure tank via an expansion tank Schrader valve fitting 735, enabling fluid communication between the bladder pressure tank and an interior of the housing.

The upper portion of the housing includes a Schrader refill valve 705, which is configured to facilitate introduction and maintenance of air pressure within the bladder pressure tank.

The alarm system further comprises a display 710, which in one embodiment is a two-digit display configured to present pressure readings, fault codes, or operational status information. The display may be implemented as a two-digit seven-segment display providing real-time feedback regarding system conditions.

A user-actuatable input in the form of a snooze/program button 715 is provided on the front surface of the housing. The snooze/program button 715 is configured to temporarily silence an audible alarm and to initiate or confirm programming operations.

The alarm system further includes one or more adjustment buttons, including a low (LO) adjustment button 720 and a high (HI) adjustment button 725. The LO adjustment button 720 is configured to decrease a programmed pressure limit, while the HI adjustment button 725 is configured to increase a programmed pressure limit, thereby enabling user configuration of pressure thresholds.

An audible alarm device, such as a speaker 730, is disposed on the housing and is configured to emit sound patterns corresponding to detected conditions of the bladder pressure tank, including bladder failure, abnormal pressure conditions, or low battery status.

The expansion tank Schrader valve fitting 735 is disposed at a lower portion of the housing and is configured to provide a removable connection between the alarm system and the Schrader valve of the bladder pressure tank. The fitting 735 may include a threaded interface configured to securely attach to the Schrader valve while allowing removal for maintenance or replacement.

The arrangement of the display 710, buttons 715, 720, 725, and speaker 730 on the housing provides an integrated user interface for monitoring, configuring, and controlling operation of the alarm system. The configuration shown in FIG. 7A represents one exemplary layout, and variations in component placement and design may be implemented without departing from the scope of the present invention.

Referring to FIG. 7B, a rear view of an alarm system is illustrated, depicting a battery access configuration of the alarm system, according to an embodiment of the present invention. The alarm system includes a housing configured to be removably coupled to a Schrader valve of a bladder pressure tank via an expansion tank Schrader valve fitting (not shown in this view).

The rear portion of the housing includes a battery door release 740, which is configured to enable access to an internal battery compartment 745. The battery door release 740 may be implemented as a latch, button, or sliding mechanism configured to allow a user to open a battery door for maintenance and replacement of a power source.

The battery compartment 745 is disposed within the housing and is configured to receive one or more batteries for supplying electrical power to the alarm system. In one embodiment, the battery compartment 745 is configured to accommodate multiple batteries, such as AAA batteries, arranged to provide sufficient operating voltage and capacity for the alarm system.

The battery compartment 745 is in electrical communication with internal components of the alarm system, including a control unit, pressure sensor, continuity switch, audible alarm, and visual indicator, thereby enabling operation of the alarm system independent of an external power source.

The configuration shown in FIG. 7B allows convenient access to the power source while maintaining a compact and enclosed housing design. The placement of the battery door release 740 and battery compartment 745 on the rear surface of the housing minimizes interference with the front-facing user interface while facilitating easy maintenance.

It will be understood that the structure and placement of the battery door release 740 and battery compartment 745 may vary depending on design requirements, and alternative configurations may be implemented without departing from the scope of the present invention.

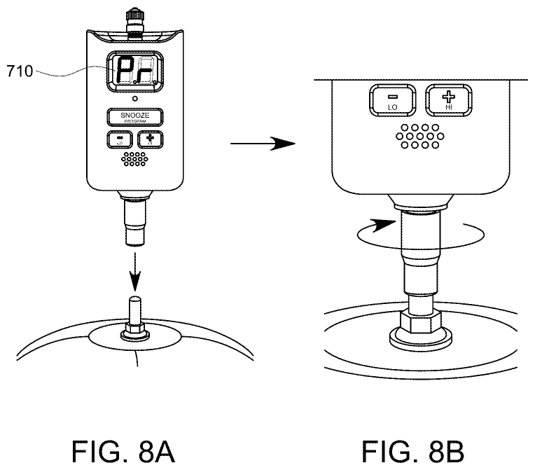

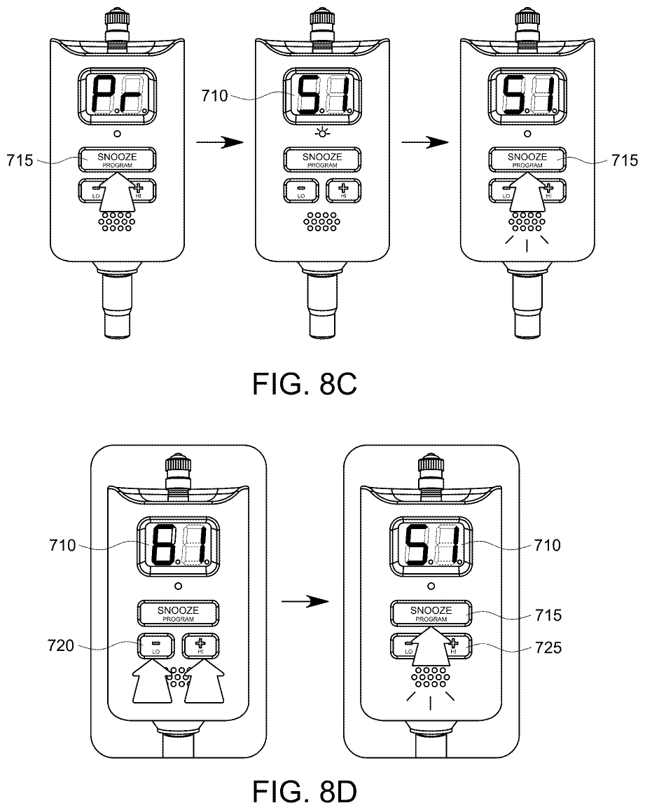

Referring to FIGS. 8A and 8B, an installation sequence of the alarm system on a bladder pressure tank is illustrated, according to an embodiment of the present invention. The figures depict positioning and coupling of the alarm system relative to a Schrader valve of the bladder pressure tank.

In FIG. 8A, the alarm system is shown in an initial alignment position above the Schrader valve of the bladder pressure tank. The housing of the alarm system is oriented such that the expansion tank Schrader valve fitting (not explicitly labelled in this figure) is aligned with the Schrader valve extending from the pressure tank. The display 710 is visible on the front surface of the housing, indicating that the device is positioned for user-facing installation.

In FIG. 8B, the alarm system is shown coupled to the Schrader valve of the bladder pressure tank via the expansion tank Schrader valve fitting. The fitting engages the Schrader valve via a rotational fastening action, as indicated by the directional arrow. The threaded engagement secures the alarm system to the pressure tank and establishes fluid communication between the Schrader valve and the interior of the housing.

Once installed, the alarm system is positioned such that the front-facing interface, including user-actuatable buttons and an audible alarm opening, remains accessible to the user. The installed configuration ensures that fluid exiting the Schrader valve upon bladder failure is directed into the housing, enabling detection by internal components such as the continuity switch and/or pressure sensor.

In an embodiment, the display 710 is configured to present alphanumeric indicators corresponding to operational states of the alarm system. For example, the display may show an indication such as “Pr,” representing a programming mode or pressure-related configuration state of the alarm system. The “Pr” indication may be displayed during initialization, setup, or when the user actuates the snooze/program button to adjust system parameters, such as pressure limits. The display 710 may further transition from the “Pr” indication to numerical values representing measured pressure or configured threshold values, thereby providing real-time feedback to the user during operation and configuration of the alarm system.

Referring to FIG. 8C, a sequence illustrating a programming operation of the alarm system is depicted, according to an embodiment of the present invention. The sequence demonstrates user interaction with the alarm system to configure pressure-related parameters via the front-facing user interface.

In a first stage, the display 710 presents an alphanumeric indication, such as “Pr,” representing a programming mode of the alarm system. The programming mode may be initiated by a user-actuatable input, such as pressing and holding the snooze/program button 715 for a predetermined duration.

In a subsequent stage, the display 710 transitions from the programming indication to a numerical value representing a current pressure measurement or a configurable pressure threshold. In one embodiment, a visual indicator associated with the display, such as a flashing light, may be activated to indicate that the system is in a configuration or adjustment state.

In a further stage, the user may adjust the displayed value using one or more adjustment buttons, including low (LO) and high (HI) adjustment inputs, to modify pressure limits or operating parameters of the alarm system.

Upon completion of the adjustment, a user input, such as a single press of the snooze/program button 715, confirms and stores the programmed value. The display 710 may then stabilize to indicate successful programming, and the alarm system returns to a normal operating mode.

Referring to FIG. 8D, a sequence illustrating adjustment of pressure limits of the alarm system is depicted, according to an embodiment of the present invention. The sequence demonstrates user interaction for modifying predefined high (HI) or low (LO) pressure threshold values.

In an initial stage, the display 710 presents a numerical value corresponding to a default pressure setting, such as a predefined high or low pressure limit. The default value may be automatically set based on standard operating conditions of the bladder pressure tank.

In a subsequent stage, a user actuates one or more adjustment buttons, including a low (LO) adjustment button 720 and a high (HI) adjustment button 725, to incrementally decrease or increase the displayed value. The display 710 dynamically updates to reflect the adjusted pressure value in real time as the user modifies the setting.

Upon reaching a desired pressure value, the user may confirm the adjustment by actuating the snooze/program button 715, for example by pressing and holding the button for a predetermined duration. In response, the alarm system stores the adjusted pressure limit as a configured operating parameter.

Following confirmation, the display 710 may provide a visual indication of successful programming, such as a steady display or a change in indicator state, and the alarm system returns to normal monitoring operation using the updated pressure thresholds.

The adjustment sequence illustrated in FIG. 8D enables user-defined customization of pressure limits, allowing the alarm system to be configured according to specific system requirements while maintaining reliable detection of abnormal pressure conditions.

Although particular embodiments of the invention have been described in detail for purposes of illustration, various modifications, and enhancements may be made without departing from the spirit and scope of the invention.

1. An alarm system for detecting failure of a bladder pressure tank, the alarm system comprising:
a housing configured to be removably coupled to a schrader valve of the bladder pressure tank and is in fluid communication with the schrader valve;
an adapter disposed on the housing;
a continuity switch disposed within the housing and comprising a plurality of electrodes positioned to be exposed to fluid entering the housing from the Schrader valve; and
an alarm output device operatively coupled to the continuity switch, and configured to be activated based on an output of the continuity switch.

2. The alarm system of claim 1, wherein the plurality of electrodes comprises a first electrode and a second electrode configured such that contact of the fluid with both the first electrode and the second electrode completes an electrical circuit, and wherein the continuity switch is configured to transition from an open state to a closed state upon completion of the electrical circuit.

3. The alarm system of claim 1, wherein the plurality of electrodes is positioned adjacent to a Schrader valve interface such that fluid exiting the bladder pressure tank contacts the plurality of electrodes.

4. The alarm system of claim 1, wherein the plurality of electrodes is disposed within or adjacent to the adapter.

5. The alarm system of claim 1, further comprising a display disposed on the housing and configured to present at least one of pressure data, operational status, and fault information, wherein the display is configured to present an alphanumeric indication corresponding to a programming mode of the alarm system.

6. The alarm system of claim 1, further comprising a user interface that comprises a snooze/program button and one or more adjustment buttons configured to receive user input, wherein the adjustment buttons comprise a low (LO) adjustment button and a high (HI) adjustment button configured to adjust a pressure threshold.

7. The alarm system of claim 1, wherein the alarm output device comprises an audible alarm configured to emit one or more sound patterns, and wherein the audible alarm is configured to emit different sound patterns corresponding to different operating conditions.

8. The alarm system of claim 1, wherein the alarm output device comprises a visual indicator configured to emit one or more light signals, and wherein the visual indicator comprises one or more light-emitting diodes configured to emit different colors corresponding to different operating conditions.

9. The alarm system of claim 1, further comprising a user-actuatable input configured to temporarily disable the alarm output device, wherein the user-actuatable input comprises a snooze button configured to deactivate the audible alarm for a predetermined time period.

10. The alarm system of claim 1, further comprising:
a power source comprising at least one of a battery or an external power supply; and
a communication module configured to transmit an alert signal to an external device,
wherein the communication module comprises a wireless communication module configured to communicate with a remote application.

11. An alarm system for detecting abnormal operation of a bladder pressure tank, the alarm system comprising:
a housing configured to be removably coupled to a schrader valve of the bladder pressure tank, and is in fluid communication with the schrader valve;
an adapter disposed on the housing;
a pressure sensor configured to measure pressure associated with the bladder pressure tank via the schrader valve;
a control unit operatively coupled to the pressure sensor; and
an alarm output device operatively coupled to the control unit,
wherein the control unit is configured to:
receive pressure measurements from the pressure sensor; and
activate the alarm output device when the pressure measurements satisfy a predefined condition indicative of abnormal operation of the bladder pressure tank.

12. The alarm system of claim 11, wherein the control unit is configured to activate the alarm output device in response to a detected pressure drop indicative of bladder degradation.

13. The alarm system of claim 11, wherein the alarm output device comprises an audible alarm configured to emit one or more sound patterns, and wherein the audible alarm is configured to emit different sound patterns corresponding to different operating conditions.

14. The alarm system of claim 11, wherein the alarm output device comprises a visual indicator configured to emit one or more light signals, and wherein the visual indicator comprises one or more light-emitting diodes configured to emit different colors corresponding to different operating conditions.

15. An alarm system for detecting degradation of a bladder pressure tank, the alarm system comprising:
a housing configured to be removably coupled to a schrader valve of the bladder pressure tank and is in fluid communication with the schrader valve;
an adapter disposed on the housing;
a pressure sensor configured to obtain pressure measurements associated with the bladder pressure tank via the schrader valve;
a control unit operatively coupled to the pressure sensor; and
an alarm output device operatively coupled to the control unit,
wherein the control unit is configured to:
collect pressure measurements over a plurality of operating cycles of the bladder pressure tank;
determine one or more pressure-response characteristics of the bladder pressure tank based on the collected pressure measurements;
establish a baseline pressure-response profile representative of normal operation of the bladder pressure tank;
compare subsequently obtained pressure measurements with the baseline pressure-response profile to identify deviations indicative of degradation of a bladder of the bladder pressure tank; and
activate the alarm output device in response to the identified deviations.

16. The alarm system of claim 15, the pressure-response characteristics including at least one of a pressure decay rate, a pressure recovery characteristic, and a pressure fluctuation pattern.

17. The alarm system of claim 15, wherein the control unit is configured to update the baseline pressure-response profile based on newly obtained pressure measurements corresponding to stable operating conditions.

18. The alarm system of claim 15, wherein the deviations indicative of degradation comprises at least one of: an increase in pressure decay rate over time, a reduction in pressure retention within the bladder pressure tank, and an increase in pressure oscillations during operation of the bladder pressure tank.

19. The alarm system of claim 15, wherein the control unit is configured to determine a degradation state of the bladder pressure tank based on a magnitude of the identified deviations.

20. The alarm system of claim 19, wherein the degradation state comprises at least one of a normal condition, an early degradation condition, and an advanced degradation condition.
